(19) United States
(12) Patent Application Publication
(10) Pub. No.: US 2010/0042526 A1
(43) Pub. Date: Feb. 18, 2010

(54) Credit-debit-chargecard and identity theft fraud prevention method

(76) Inventor: Norman P. Martinov, Woodland Hills, CA (US)

Correspondence Address: NORMAN P. MARTINOV, 4744 DEL MORENO DRIVE, WOODLAND HILLS, CA, 91364, US

(21) Appl. No.: 12/462,471

(22) Filed: Aug. 5, 2009

Related U.S. Application Data
(60) Provisional application No. 61/188,783, filed on Aug. 13, 2008.

(51) Int. Cl. G06Q 40/00

(52) U.S. Cl. 705/35

(57) ABSTRACT

A new method of fraud prevention for lost, stolen, cloned or on-file creditcards, debitcards and chargecards. This same method will prevent fraudulent transfer of funds from on-line or off-line bank accounts and will prevent the establishment of creditlines or loans in the name of an unwitting consumer. Furthermore, this method can prevent unauthorized accessing of secured computer sites. The method comprises a pre-determined dedicated telephone terminal data-base which is interfaced and/or in communication with: normally closed credit-debit-charge card funding approvalsa; normally blocked banking transactions; normally unauthorized creditline or loan approval; normally inaccessable secured computer sites whereby a consumer-cardholder-subscriber can call the said dedicated telephone terminal database and together with a pre-determined authentication means can open, authorize, approve or access the normally closed/denied operations outlined above for a pre-determined number of transactions and/or time limit just before using them. After transaction(s) and/or time limit expires the open-approval condition will default to the closed-denial mode where it will continue until consumer-cardholder-subscriber wants to re-open the above operations temporarily for his/her own use. It should be obvious that fraud perpetrators will never know when these operations will be activated for brief periods of time and therefore will not be able to perpetrate the fraud. The additional authentication required for the consumer-cardholder-subscriber can be a personal identification number (PIN) and/or password and/or telephone number identification means and/or biometric means especially voice recognition identification on the telephone.

### CROSS-REFERENCE TO RELATED APPLICATIONS

This application is entitled to the benefit of Provisional Patent Application Ser. No. 61/188,783 filed Aug. 13, 2008.

### BACKGROUND—STATEMENT REGARDING FEDERALLY SPONSORED RESEARCH DEVELOPMENT

Not Applicable

### BACKGROUND

1. Field of Invention

This invention relates to the prevention of the: fraudulent use of lost, stolen, cloned or on-file credit debit or charge cards; unauthorized on-line or off-line bank fund transfer or withdrawl; unauthorized fraudulent opening of credit lines or loans; unauthorized accessing of secured computer sites.

2. Description of Prior Art

Present day solutions for fraudulent use of lost, stolen, cloned or on-file creditcards, debitcards, or charge cards; unauthorized bank fund transfer or withdrawl; fraudulent opening of credit lines or loans; or unauthorized accessing of secured computer sites do not employ active prevention methods but rather, rely on passive after-the-fact repair which result in the loss of funds, damage of credit scores, unauthorized access of secured computer sites and untold hours of work to repair credit history and undo identity theft damage. Since present methods of fraud remedies and repairs rely on after-the-fact damage control, fraudsters are usually never apprehended and money is lost. Another problem of present day methods is that creditcard, debitcard, chargecard funding means are always in the open accessable condition when a fraudster is operating and are only closed after-the-fact.

### SUMMARY

A new method to defeat the fraudulent use of lost, stolen, cloned or on-file creditcard, debitcard, chargecard, bank account transfer or withdrawl and fraudulent opening of creditlines or loans, comprised of a dedicated telephone terminal data-base of cardholder-subscribers whose accounts are always in a normally closed condition until cardholder-subscriber opens them temporarily by telephone call (wireless or landline) for a given amount of transactions and/or time. Access to secured computer sites can also be accomplished in accordance with the above method. For additional security, telephone terminal database can also require personal identification number (PIN), caller telephone number recognition, voice recognition or password means before opening, approving or authorizing any of the above transactions.

### Objects and Advantages

Accordingly, several objects and advantages of the present invention are:
(a) to defeat fraudulent use of creditcards
(b) to defeat fraudulent use of debitcards
(c) to defeat fraudulent use of pre-paid chargecards
(d) to defeat fraudulent fund withdrawls or transfers from bank accounts (off-line or on-line)
(e) to prevent establishment of fraudulent credit lines and/or loans
(f) to prevent accessing of secured computer sites
(g) to reduce monetary losses to consumers, creditcard companies, banks and businesses
(h) to control when and how employees use issued creditcards and debitcards
(i) to institute fraud prevention rather than after-the-fact damage control
(j) to keep credit-debit-charge cards, bank accounts, credit inquiries and secured computer sites continually closed until legal cardholder-subscriber opens them for use
(k) to provide a special, safe credit-debit-charge card to be used in fraud prone situations
(l) to provide a method which more readily lends itself to fraudster apprehension

Further objects and advantages of my invention will become apparent from a consideration of the ensuing conclusions and description.

### Conclusion, Ramifications and Scope

Other ramifications, scope and enlightenment can be found in the Provisional Patent Application referenced in this application.

It should be apparent that the viability of this invention is mainly due to the ubiquity of the wireless telephone. Furthermore, the dedicated telephone terminal data-base can be considered a central clearinghouse containing cardholder-subscriber normally closed accounts, closed credit inquiry and computer sites which can temporarily be opened by cardholder-subscriber telephone call. In addition to the cardholder-subscribers call to the pre-determined telephone terminal, a personal identification number (PIN) and/or password and/or biological identification (voice recognition) and/or telephone identification number recognition means can be required. It should be noted that the pre-determined dedicated telephone terminal data-base can be in any location. In addition to its main objective of fraud prevention, it can also be used by businesses, federal/local government, etc. to control when and how employees use company-issued credit and debit cards when the employers are in control of the means to open and approve their use. Since the invention is a method-process and not a mechanical device, this application-specification does not contain drawings.

### DETAILED DESCRIPTION OF THE INVENTION

The subject of this invention is the use of a dedicated telephone terminal data-base apparatus means which is interfaced and/or in communication with a normally closed creditcard, debitcard or charge card funding approval means; bank account fund withdrawl or transfer approval means; loan authorization inquiry means; or secured computer site access means, whereby a cardholder-subscriber can call the said telephone terminal means and together with an authentication means can temporarily open, approve, authorize or access the here-in-above operations for a pre-determined number of transactions and/or time. The cardholder-subscriber-consumer can use landline or wireless (cell, satellite or radio) telephone to call said dedicated telephone terminal data-base means and together with an authentication means can temporarily unlock the here-in-above blocked operations just before the need to use them. The authentication means can be a personal identification means (PIN) and/or password and/or telephone caller identification means and/or biometric means—especially voice recognition. While the dedicated telephone terminal means can be a live operator, the preferred method would be an automated-attendant means. While the normally closed funding approval; bank transaction approval; credit line loan inquiry approval; secured computer site accessing can be authorized by the cardholder-subscriber-consumer for any number of transactions and/or period of time, a preferred embodiment could be to be opened for one transaction or fifteen minutes—whichever came first then would automatically default to the closed condition until the legal cardholder-subscriber opens the operation for a future transaction. It should be observed that the above method would be an active prevention method against fraudulent use of lost, stolen, cloned or on-file credit-debit-charge cards; fraudulent bank account withdrawls or transfers; un-authorized loans or credit lines; unauthorized computer site access. It should also be noted that the here-in-above operations are always in the closed/blocked condition until opened/unblocked by the legal cardholder-subscriber-consumers. Although the here-in-above method can be considered to be another layer of protection against fraudulent use of lost, stolen, cloned and “on-file” credit, debit or charge cards; bank account fund transfers or withdrawls; inquiries to establish illegal loans or creditlines; unauthorized access to secured computer sites, it may well be the most important fraud barrier due to the fact that it is an active preventive measure rather than a passive after-the-fact damage control measure.

In regard to the ease of operation of the here-in-above methods, the dedicated telephone terminal number that would be called for temporary opening-approval-thawing-authorizing-accessing can be placed on the consumer-cardholder-subscriber's telephone speed dial.

In addition to the prevention of the fraudulent use of lost, stolen, cloned or on-file creditcards, debitcards or chargecards or unauthorized computer access, companies, institutions or business owners, including managers or supervisors, can use the above methods to control when and how employees use cards or access computer sites.

In regard to the operation of the method's use to authorize the opening of creditlines or loans in the name of the consumer-subscriber, fraud alerts would be placed on the credit bureaus records of the subscriber which directs the creditline or loan originator to call the dedicated telephone terminal numbers data-base which would be in a normally unauthorized mode unless the subscriber had just called to authorize the creditline or loan.

I claim:

1. A new use of a dedicated telephone terminal data-base interfaced and/or in communication with a normally closed credit card funding approval whereby a cardholder-subscriber can call the telephone terminal by wireless or landline telephone for a new purpose to temporarily open/approve credit card funding for a given number of transactions and/or period of time after which the approval would default to the closed/denial/unauthorized mode until cardholder-subscriber again opens approval in the above manner just before his or her use.

2. The method of claim 1 whereby the dedicated telephone terminal data-base is interfaced and/or in communication with a normally closed debitcard account.

3. The method of claim 1 whereby the dedicated telephone terminal data-base is interfaced and/or in communication with a normally closed chargecard account.

4. The method of claim 1 whereby the dedicated telephone terminal data-base is interfaced and/or in communication with a normally closed pre-paid chargecard.

5. The method of claim 1 whereby the dedicated telephone terminal data-base is interfaced and/or in communication with a normally closed bank account especially in regard to fund withdrawl or transfer.

6. The method of claim 1 whereby the dedicated telephone terminal data-base is interfaced and/or in communication with a normally unauthorized response to credit bureau directed inquiries trying to fraudulently authorize establishment of a creditline or loan in the name of the consumer-subscriber.

7. The method of claim 1 whereby the dedicated telephone terminal data-base is interfaced and/or in communication with normally closed access to a secured computer site.
